(19) United States
(12) Patent Application Publication
(10) Pub. No.: US 2026/0317593 A1
(43) Pub. Date: Oct. 15, 2026

(54) RESIN COMPOSITIONS FOR LOW MODULUS OPTICALLY CLEAR ADHESIVES WITH ENHANCED ADHESION AND METHODS OF PREPARING THE SAME

(71) Applicant: Ares Materials Inc., Dallas, TX (US)

(72) Inventors: Sudheendran Mavila, Sachse, TX (US); David Arreaga, Garland, TX (US); Adrian Avendano-Bolivar, Prosper, TX (US)

(21) Appl. No.: 19/320,074

(22) Filed: Sep. 5, 2025

Related U.S. Application Data
(60) Provisional application No. 63/691,965, filed on Sep. 6, 2024.

(51) Int. Cl. C09J 9/00; C09J 7/30; C09J 11/06; G06F 1/16

(52) U.S. Cl. CPC C09J 9/00; C09J 7/30; C09J 11/06; G06F 1/1607; G06F 1/1652; C09J 2301/408; C09J 2301/416

(57) ABSTRACT

A thiol-based optically clear adhesive (OCA) includes a polymeric resin composition that embodies enhanced adhesion to various substrates (including transparent substrates) as a film. The polymeric resin composition includes an ex-situ/in-situ synthesized adhesion promoter that enables enhanced adhesion capabilities, particularly to glass and PET substrates. The adhesion promoter may also be suitable for use with various types of OCAs including, but not limited to: polysulfides, polyester, silicone, or acrylic-based OCAs. The polymeric resin composition can be particularly suitable as laminating films, tapes, or encapsulants for adhering to display electronic devices such as LCDs, OLEDs, flexible and foldable displays, and touch screens. The polymeric resin composition is additionally applicable to fields of use for such display devices, such as heads-up displays in automotive vehicles and night-vision devices.

### CROSS-REFERENCE TO RELATED APPLICATIONS

This application claims priority to U.S. Provisional Patent Application No. 63/691,965, filed Sep. 6, 2024, and entitled “RESIN COMPOSITIONS FOR LOW MODULUS OPTICALLY CLEAR ADHESIVES WITH INSTANT ADHESION AND METHODS OF PREPARING THE SAME,” the entire disclosure of which is incorporated herein by reference for all purposes.

### BACKGROUND

The development of plastic-based electronic devices has led to an increasing demand for durable, lightweight, and foldable materials. However, creating such materials requires significant innovation in material design to accommodate flexible display applications. Optically clear adhesives (OCAs) help to retain the elasticity necessary for these applications by reducing stress on display components at a wide temperature range during folding. The materials designed for foldable displays must have high optical transparency greater than 90% as well as long-term reliability with minimal yellowing from heat, humidity, and UV rays. These materials must also be designed to achieve an ultra-low modulus of less than 500 KPa within a wide temperature range (for example, −20° C. to 60° C.) along with high enhanced adhesion of greater than 800 gf/in to various transparent substrates such as glass and PET without any pretreatment or post-treatment.

Current polyacrylate-based OCAs encounter difficulties maintaining the desired low modulus and optical reliability when exposed to extreme thermal aging conditions. Furthermore, most OCAs utilize tackifiers that compromise optical clarity and result in a sticky film that is challenging to handle. In addition, achieving strong adhesion to various substrate surfaces (such as glass and PET) poses a significant challenge. Therefore, a challenge remains in developing OCAs embodying the aforementioned characteristics.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is an illustration of a cross-sectional view of an optical laminate in accordance with certain embodiments of the present disclosure;

FIG. 2 is an illustration of a cross-sectional view of a flexible display in accordance with certain embodiments of the present disclosure; and

FIG. 3, which is an illustration of a table depicting storage modulus curves of an optically clear adhesive measured over three weeks in accordance with certain embodiments of the present disclosure.

The illustrated figures are only exemplary and are not intended to assert or imply any limitation with regard to the environment, architecture, design, or process in which different examples may be implemented.

### DETAILED DESCRIPTION

The present disclosure relates generally to materials relative to the field of resin compositions for flexible display technologies, and more particularly to methods for creating solvent-free, photo-curable resin blends for forming an enhanced optically clear adhesive (OCA) for flexible displays and other applications using non-covalent carboxyl-amide-based chemistry processes, the processes of which are not replicable using silane or epoxy chemistry approaches. The present disclosure further relates to adhesion promoters, and more particularly to carboxyl-based adhesion promoter compounds, methods of use, and methods of ex-situ/in-situ synthesis.

In regard to the present disclosure, the term “adhesive” can include both permanent adhesives and pressure-sensitive adhesives (tacky adhesives). Further in regard to the present disclosure, the term “percent” refers to a weight of a component of a composition based on the total weight of all of the components. Further in regard to the present disclosure, the term “cross-linker” refers to a covalent bond or a sequence of covalent bonds that connect one polymer chain to another. Further in regard to the present disclosure, the term “adhesion promoter” refers to a chemical compound or an additive that enhances the bonding between two surfaces. Further in regard to the present disclosure, the term “film” refers to a free-standing adhesive with a thickness of 30 to 60 micrometers that adheres components and/or substrates together in/in association with a device. In certain embodiments, the term “film” may refer to a free-standing adhesive with a thickness of 25 to 100 micrometers that adheres components and/or substrates together in/in association with a device. It is noted that the larger thickness range (25 to 100 micrometers) may increase the number of potential applications of the disclosed film. It is further noted that films having thicknesses up to 100 micrometers may be effectively cured (and avoids the problem of light attenuation during curing).

Further in regard to the present disclosure, the term “optically clear” refers to a 90% or greater transmission of light (luminous transmittance) measured for a film at 400 nm or above. It is noted that luminous transmittance can be determined in accordance with JIS K 7361 (1997). Additionally, the term “optically clear” generally refers to a state in which air bubbles cannot be visually observed. In relation to the term “optically clear”, an optically clear polymer may exhibit the property of haze, which is defined as the percentage of regular rays (of light) that are diffracted greater than 2.5 degrees from the normal (in accordance with ASTM 1003). In addition, an “optically clear” polymer may exhibit a haze value of approximately 1% or less. Further in regard to the present disclosure, the term “storage modulus (G′)” refers to the storage modulus of a material at a specific temperature when a rate of temperature increase is measured at 5° C./min. and viscoelasticity is measured in a 1.0 Hz shear mode within a temperature range of −40° C. to 100° C. In relation to this disclosure, the storage modulus of disclosed polymers was measured using a TA Instruments® (a registered trademark of Waters Technology Corporation) HR20 Rheometer. Further in regard to the present disclosure, the term “enhanced adhesion” refers to the property of an adhesive achieving a peel strength with an adherent surface of greater than 800 gf/in with a dwell time of less than 24 hours and without any pretreatment or post-treatment of the adhesive or the adherent surface. Further in regard to the present disclosure, the term “non-covalent”, in relation to the carboxyl-amide-based chemistry processes disclosed, refers to molecular physical interactions that do not involve the formation of chemical bonds and that mainly occur via weak interactions such as, for example, hydrogen bonding, ionic interactions, and Van der Waals forces. In embodiments disclosed, the non-covalent interactions may mostly occur from hydrogen bonding.

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure.

Unless otherwise indicated, all numbers expressing quantities of components, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

Presented herein is an optically clear adhesive (OCA) having a polymeric resin composition configured for inclusion in flexible display technologies/materials. The polymeric resin composition comprises a multifunctional thiol monomer, a first multifunctional allyl monomer, and a second multifunctional allyl monomer. The polymeric resin composition further comprises a difunctional adhesion-promoting monomer, a photoinitiator, and a wetting additive. For flexible display technology applications, the polymeric resin composition is cured into a film.

Additionally presented herein is a method to synthesize a multifunctional adhesion promoter within the polymeric resin composition or separately without any solvent. The multifunctional adhesion promoter may be utilized in formulating a stable resin blend containing specific ratios of multifunctional monomers and additives to enhance mechanical stability and optical performance of the OCA. It is understood that the term “stable resin” refers to a homogeneous resin mixture (containing all components) that includes a sufficient pot life. It is further understood that the term “sufficient pot life” refers to the duration for which the homogeneous resin mixture retains consistent properties for at least 12 hours after mixing.

Additionally presented herein is an optical laminate comprising a first base layer having a first surface, a second base layer having a second surface, and an adhesive layer, where the adhesive layer includes the optically clear adhesive as described in the previous paragraph positioned between the first surface of the first base layer and the second surface of the second base layer so as to adhere the first surface of the first base layer to the second surface of the second base layer.

Additionally presented herein is a flexible display comprising a window layer, a polarizer layer, a display layer, a support film layer and a plurality of adhesive layers, where each of the plurality of adhesive layers include the optically clear adhesive as described in a previous paragraph, further where a first adhesive layer of the plurality of adhesive layers is positioned between a first surface of the window layer and a first surface of the polarizer layer, a second adhesive layer is positioned between a second surface of the polarizer layer and a first surface of the display layer, and a third adhesive layer is positioned between a second surface of the display layer and a first surface of the support film layer so as to adhere the first surface of the window layer to the first surface of the polarizer layer, the second surface of the polarizer layer to the first surface of the display layer, and the second surface of the display layer to the first surface of the support film layer.

According to one or more embodiments of the present disclosure, a polymeric resin composition is provided that is suitable as laminating films, tapes, or encapsulants for adhering to display electronic devices such as LCDs, OLEDs, flexible and foldable displays, and touch screens. The polymeric resin composition is additionally applicable to fields of use for such display devices, such as heads-up displays in automotive vehicles and night-vision devices. In additional embodiments of the present disclosure, an adhesion promoter is provided that is compatible with various monomers and polymer systems such as various types of OCAs including, but not limited to: polysulfides, polyester, silicone, or acrylic-based OCAs. When the adhesion promoter is cured with an OCA, an OCA film embodying excellent adhesion properties is produced that is also less tacky and easier to handle than standard OCA films. The cured film also maintains high optical and mechanical properties while also enhancing adhesion to transparent substrates such as glass and PET. It is further noted that the carboxy-amide-based synthesis utilized to produce the low-modulus, thiol-based OCAs disclosed addresses critical issues associated with silane chemistry, such as decreased adhesive properties over time due to the self-coupling reactions of activated silanol (which impacts the mechanical performance of OCAs over time). In addition, the low-modulus, thiol-based OCAs exhibit adhesion to substrates other than glass such as, for example, PET.

According to an embodiment of the present disclosure, an optically clear adhesive includes a stable polymeric resin blend composition configured for inclusion in flexible display technologies/materials. The composition of the adhesive utilizes certain multifunctional monomers and additives that are combined in a solvent-free resin blend that includes a multifunctional adhesion promoter formed either ex-situ or in-situ. The polymeric resin composition comprises a multifunctional thiol monomer, a first multifunctional allyl monomer, and a second multifunctional allyl monomer. The polymeric resin composition further comprises a difunctional adhesion-promoting monomer, a photoinitiator, and a wetting additive. In a more specific embodiment, the polymeric resin composition comprises about 30% to about 60% of a difunctional thiol monomer, about 20% to about 60% of a difunctional allyl monomer, about 1% to about 5% of a trifunctional allyl monomer, about 10% of a synthesized adhesion promoter, about 2% of a phosphine oxide-based photoinitiator, and about 0.3% of a wetting additive. In an additional more specific embodiment, the polymeric resin composition comprises 57.41% of a multifunctional thiol monomer, 28.11% of a first multifunctional allyl monomer, 2.18% of a second multifunctional allyl monomer, 10.0% of a difunctional adhesion-promoting monomer, 2.0% of a photoinitiator, and 0.3% of a wetting additive.

For flexible display technology applications, the polymeric resin composition is cured into an adhesive film, where the polymeric resin composition is cured into the film using UV light having an intensity from 2-6 J/cm² under ambient temperature. In certain embodiments, the UV light may be UVA light having a wavelength between 315 and 380 nm. This wavelength range may ensure maximum curing depth, which may lead to efficient curing of the adhesive film. When carried out, the curing process requires no post-treatment or annealing other than UV light, resulting in a less tacky and optically clear film. The fully cured film produced embodies a salient mechanical stability with a modulus of less than 400 kPa at −20° C. and greater than 20 kPa at 60° C. The cured film also embodies salient optical properties with an optical transmission rate of greater than 90% within the visible region and a yellowing index and haze of less than 1.0 and approximately less than 1%, respectively. Additionally, the film embodies a glass transition temperature between −20° C. and −60° C. and further exhibits a first storage modulus between 0.05 and 0.1 MPa at −20° C. and a second storage modulus between 0.01 and 0.05 MPa at 60° C. when a rate of temperature increase is measured at 5° C./min and viscoelasticity is measured at a 1.0 Hz shear mode within a temperature range of −40° C. to 100° C.

A thiol monomer is a main component of the polymeric resin composition of the OCA. In certain embodiments, the thiol monomer is multifunctional and comprises a functionality of 2 (difunctional) or 3 (trifunctional). A “difunctional” thiol monomer, for reference purposes herein, comprises a chemical species that includes two thiol-based unsaturated moieties. Similarly, a “trifunctional” thiol monomer comprises a chemical species that includes three thiol-based unsaturated moieties. Exemplary difunctional thiols that can be utilized include, but are not limited to: 1,4-bis(3-mercaptobutyroyloxy) butane, ethylene glycol bis-mercaptoacetate, ethylene bis(3-mercaptopropionate), 2,2′-(ethylenedioxy) diethanethiol, or 1,10-decanedithiol. In one embodiment, a species include: 1,4-bis(3-mercaptobutyroyloxy) butane or ethylene bis(3-mercaptopropionate). Exemplary trifunctional thiols that can be utilized include, but are not limited to: trimethylolpropane tris(3-mercaptopropionate) or tris [2-(3-mercaptopropionyloxy)ethyl]isocyanurate. In an embodiment, a species includes: tris [2-(3-mercaptopropionyloxy)ethyl]isocyanurate.

An allyl monomer is another main component of the polymeric resin composition of the OCA. In certain embodiments, the allyl monomer comprises a functionality of 2 (difunctional) or 3 (trifunctional), the concept of which is understood in reference to the previous paragraph. Exemplary difunctional allyl monomers that can be utilized include, but are not limited to: diallyl isophthalate or trimethylolpropane diallyl ether. Exemplary trifunctional allyl monomers that can be utilized include, but are not limited to: 1,3,5-triallyl-1,3,5-triazine-2,4,6 (1H,3H,5H)-trione or pentaerythritol triallyl ether. In an embodiment, a species includes: 1,3,5-triallyl-1,3,5-triazine-2,4,6 (1H,3H,5H)-trione.

A photocurable diallyl functional adhesion promoter is another main component of the polymeric resin composition of the OCA. The adhesion promoter can be synthesized either in-situ with the resin components, or ex-situ without using any solvents. In embodiments, the adhesion-promoting monomer comprises carboxyl and amide functionalities. Unlike commercially available monoacrylate-based adhesion promoters, the disclosed adhesion promoter includes photopolymerizable terminal alkenes having a functionality of greater than 1 in order to prevent chain termination events that negatively impact the disclosed OCA's mechanical and optical properties. Exemplary diallyl functional adhesion promoters that can be utilized include, but are not limited to: diallyl succinimide monocarboxylic acid (DASAm), as referenced in Para. [0028] herein. It is noted that additional modifications to diallyl functional adhesion promoters may be carried out using the information in Reaction Formula 1 and Paras. [0025] and [0026] herein.

It is noted that, in embodiments, the disclosed OCA film achieves an adhesion force with different substrates (such as, for example, glass and PET) of greater than 800 gf/in under ambient conditions and without requiring pre-activation or post-treatment of functional groups of the OCA. It is further noted that the film may be activated by corona treatment in order to enhance the adhesion property to greater than 1000 gf/in.

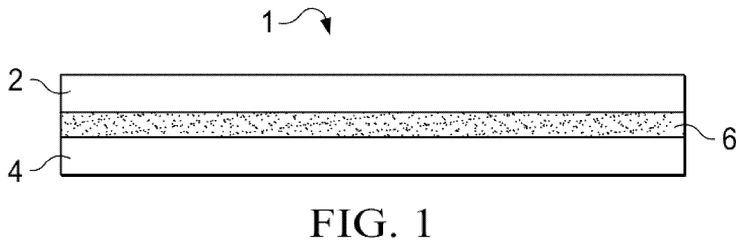

FIG. 1 is an illustration of a cross-sectional view of an optical laminate 1 in accordance with certain embodiments of the present disclosure. As shown, optical laminate 1 includes an adhesive layer 6 including an OCA positioned between and in contact with a first surface of a first base layer 2 and a second surface of a second base layer 4. Adhesive layer 6 may be in direct contact with the first surface of the first base layer 2 and the second surface of the second base layer 4. In other embodiments, adhesive layer 6 may be in indirect contact with the first surface of the first base layer 2 and the second surface of the second base layer 4, where one or more additional layers (not depicted) are positioned between adhesive layer 6 and the first surface of the first base layer 2 and between adhesive layer 6 and the second surface of the second base layer 4. The additional layers may include layers such as, but not limited to, hard coat layers, primer layers, polarizing layers, light emitting layers, or color filter layers. It is further noted that adhesive layer 6 may comprise any embodiment of an OCA disclosed.

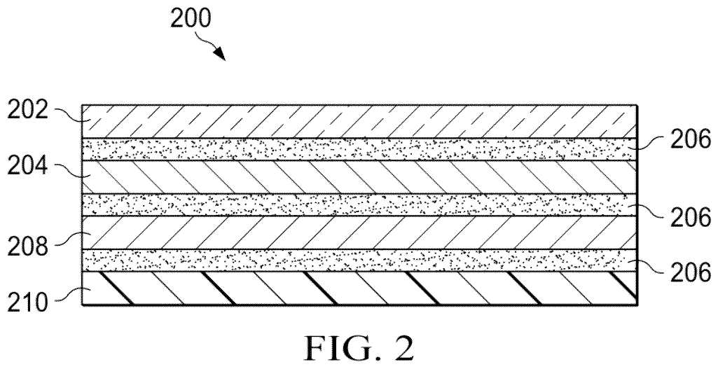

FIG. 2 is an illustration of a cross-sectional view of a flexible display 200 in accordance with certain embodiments of the present disclosure. As shown, flexible display 200 includes a plurality of layers generally associated with a flexible display and includes a window layer 202, a polarizer layer 204, a display layer 208, and a support film layer 210. An adhesive layer 206 including an OCA is positioned between each pair of layers (202/204, 204/208, and 208/210). More specifically, one adhesive layer 206 of a plurality of adhesive layers 206 is positioned between and in contact with a first surface of window layer 202 and a first surface of polarizer layer 204, another adhesive layer 206 is positioned between and in contact with a second surface of polarizer layer 204 and a first surface of display layer 208, and another adhesive layer 206 is positioned between and in contact with a second surface of display layer 208 and a first surface of support film layer 210.

In other embodiments, adhesive layers 206 may be in indirect contact with the first surface of window layer 202, the first surface of polarizer layer 204, the second surface of polarizer layer 204, the first surface of display layer 208, the second surface of display layer, and the first surface of support film layer 210, where one or more additional layers (not depicted) are positioned between adhesive layers 206 and the first surface of window layer 202, the first surface of polarizer layer 204, the second surface of polarizer layer 204, the first surface of display layer 208, the second surface of display layer, and the first surface of support film layer 210. The additional layers may include layers such as, but not limited to, hard coat layers, primer layers, polarizing layers, light emitting layers, or color filter layers. It is noted that adhesive layers 206 may comprise any embodiment of an OCA disclosed. It is additionally noted that additional layers that are utilized in a flexible display and are separated by additional adhesive layers 206 can be included in the embodiment of flexible display 200, which can be recognized and understood by one skilled in the art.

According to an embodiment of the present disclosure, a method for synthesizing a difunctional adhesion promoting monomer of an OCA utilizes a process illustrated by following Reaction Formula 1 that is carried out below.

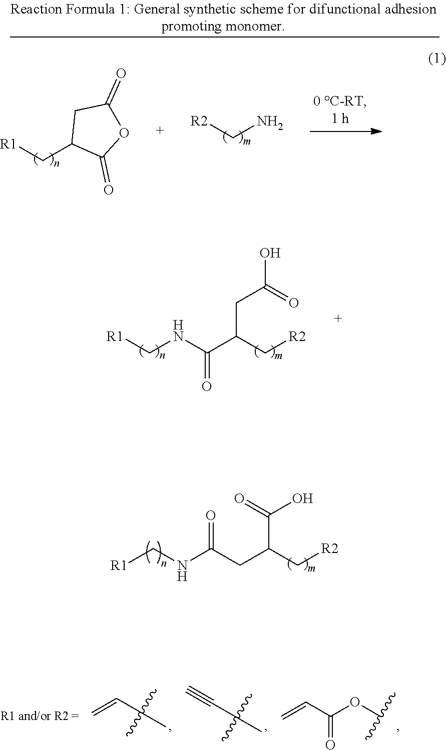

In embodiments, a synthesis method shown in Reaction Formula 1 above is disclosed which includes combining a cyclic anhydride compound bearing photopolymerizable functional groups with an amine compound bearing photopolymerizable functional groups. For both compounds, the photopolymerizable functional groups (R1 and R2) may include, but are not limited to: terminal alkenes, terminal alkynes, or terminal acrylates. As depicted, the reaction is solvent-free and involves the slow addition and subsequent mixing of the compounds under a nitrogen atmosphere. As a result of the reaction, a versatile multifunctional adhesion-promoting monomer is produced embodying excellent hydrolytic stability. Furthermore, the reaction proceeds without producing any side products or solvent residues in the final product, which reduces the cost, waste, and environmental impact of the reaction process.

According to an embodiment of the present disclosure, a method for synthesizing a specific difunctional adhesion promoting monomer (diallylsuccinimido monocarboxylic acid, or DASAm) of an OCA utilizes a process illustrated by following Reaction Formula 2 that is carried out below.

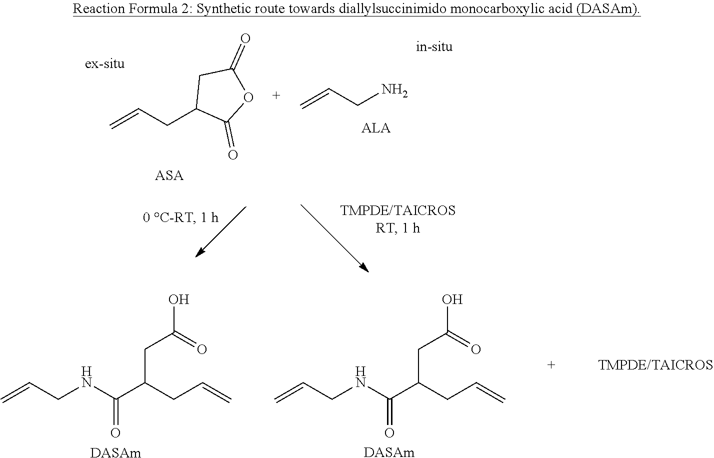

In embodiments, a synthesis method shown in Reaction Formula 2 above is disclosed which includes combining ASA and ALA in an ex-situ preparation to form DASAm, or diallylsuccinimido monocarboxylic acid. Reaction Formula 2 additionally includes combining ASA and ALA in an in-situ preparation to form DASAm and TMPDE/TAICROS.

In embodiments of the method of forming low modulus, optically clear adhesives embodying enhanced adhesion, the method comprises utilization of a specific ratio of multifunctional monomers in order to achieve a specific cross-link density, ensuring that the low storage modulus is within the temperature range of −20° C. to 60° C. More specifically, by maintaining a diallyl monomer to cross-linker (triallyl monomer) ratio between 5 to 1 and 10 to 1 and a weight percentage of adhesion-promoting monomer at about 10 wt. %, a modulus below 400 kPa and an adhesion force greater than 800 gf/in (to glass substrates, for example) is achieved.

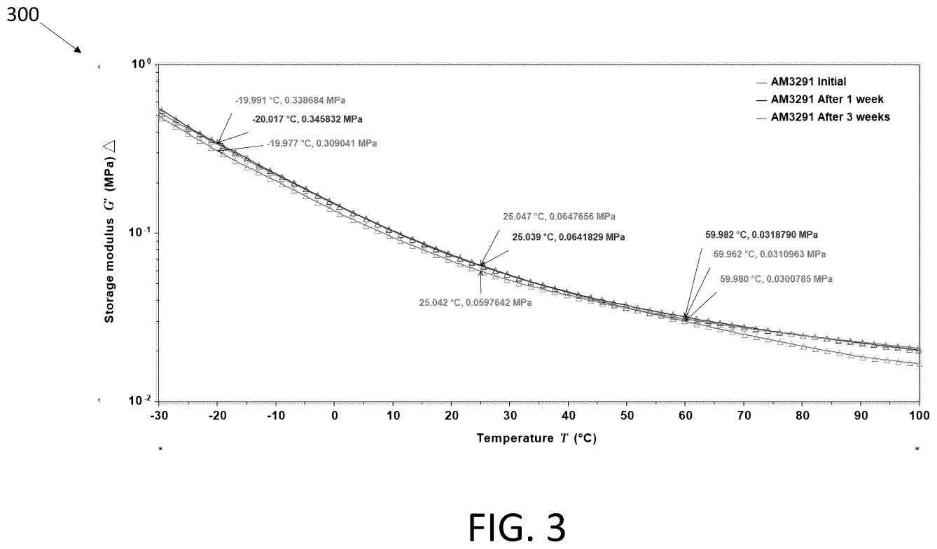

FIG. 3 is an illustration of a table 300 depicting storage modulus curves of an optically clear adhesive measured over three weeks in accordance with certain embodiments of the present disclosure. As shown, the curves were created from data collected by a Rheometer from the analysis of a disc (600 μm thick and 8 mm in diameter) formed by stacking 12 pieces of 50 μm thick cured OCA film. The data of the curves were collected from Sample AM3291, where the first curve data was collected just after the OCA film was cured, the second curve data was collected one week after the first curve data was collected, and the third curve data was collected three weeks after the first curve data was collected. Overall, due to the proximity of the three curves, it can be understood that the OCA film retained most of its viscoelasticity since its initial production.

### EXAMPLES

The invention is further described in the following examples, which are included for the purpose of illustration and are not intended to limit the scope of this invention in any way. The parts of each component are given in weight percentage of the total weight of the composition. It is noted that the carboxy-based adhesion promoter can be synthesized within the resin (in-situ) or separately (ex-situ).

### Example 1

Ex-situ synthesis of diallyl functionalized, carboxy-based adhesion promoter.

Allyl succinic anhydride (1 equiv.) was weighed into a 20 mL vial with a magnetic stir bar. The vial was cooled in a bath to 0° C. Allyl amine (1 equiv.) was added dropwise at 0° C. After the addition, the bath was removed, and the mixture was stirred at ambient temperature for one hour while the mixture slowly reached ambient temperature over the hour. The viscous liquid obtained is used as is without any further purification.

### Example 2

Optically clear resin blend using ex-situ synthesized adhesion promoter.

The optically clear resin blend was prepared by dissolving BAPO (2 wt. %) in BD1 (57.41%) in a 250 mL flat-bottomed plastic container. The mixture was speed-mixed at 2000 rpm to obtain a clear homogenous mixture. To the above mixture, TMPDE (21.1 wt. %), TAICROS (2.18 wt. %), DASAm (adhesion promoter, 10 wt. %), and BYK333 (0.3 wt. %) were added and speed-mixed for 10 min at 2000 rpm to obtain a clear homogenous resin. The following table illustrates the components of an example OCA resin composition:

TABLE 1
Resin composition of OCA by using ex-
situ synthesized adhesion promoter.

| Components | Weight % |
|---|---|
| BD1 | 57.41% |
| TMPDE | 28.11% |
| TAICROS | 2.18% |
| DASAm | 10.00% |
| BAPO | 2.00% |
| BYK 333 | 0.30% |

### Example 3

Optically clear resin blend using in-situ synthesized adhesion promoter.

The optically clear resin blend by in-situ synthesized adhesion promoter was prepared by dissolving allyl succinic anhydride (7.11 wt. %) in TMPDE (28.11 wt. %) and TAICROS (2.18 wt. %). Allylamine (2.90 wt. %) was added dropwise to the above mixture at room temperature. After mixing for 10 min. at 2000 rpm, BD1 (57.41%), BAPO (2 wt. %) and BYK333 (0.3 wt. %) were added and speed-mixed for 10 min. at 2000 RPM to obtain a clear homogenous resin. The following table illustrates the components of an example OCA resin composition:

TABLE 2
Resin composition of OCA by using in-
situ synthesized adhesion promoter.

| Components | Weight % |
|---|---|
| BD1 | 57.41% |
| TMPDE | 28.11% |
| TAICROS | 2.18% |
| Allyl succinic anhydride | 7.11% |
| Allylamine | 2.90% |
| BAPO | 2.00% |
| BYK 333 | 0.30% |

The following table illustrates some of the properties of an example OCA resin composition:

TABLE 3
Properties of OCA resin composition.

| Properties | | | AM3282/ex-situ | AM3438/in-situ |
|---|---|---|---|---|
| Optical | T (%) | | 92.0 | 92.0 |
| | Haze (%) | | 0.24 | 0.32 |
| | Y.I | | 0.69 | 0.51 |
| | RI | | 1.522 | 1.522 |
| Mechanical | Rheometer E′ | −20 °C | 0.338 | 0.310 |
| | (MPa) | 25 °C | 0.063 | 0.068 |
| | | 60 °C | 0.029 | 0.037 |
| | Tan delta | 25 °C | 0.632 | 0.543 |
| | Tg (°C) | | −38 | −39 |
| | Adhesion (gf/in) | Glass | 954 | 997 |

It is noted that adhesion was measured using a Mark-10 Tensile Tester equipped with a Mark-10 Model M5-5-20N Max Force Gauge. The sample dimensions were 24.5 mm×100 mm, while the peeling angle was 180 degrees and the peeling speed was set to 300 mm/min.

For the purposes of this disclosure, the terms “adhesion-promoting monomer” and “adhesion promoter” may be synonymous.

It is noted that embodiments of chemistry methods provided in the present disclosure may be applied to chemical/molecular formulations that require solvent-based processing.

One or more embodiments of this disclosure present materials for constructing higher quality and higher performing flexible display technologies in relation to other flexible display technologies.

It is noted that the optically clear adhesives (OCAs)/polymeric resins presented herein may be utilized in a display/display device/display panel that may be flexible or inflexible. The optically clear adhesives (OCAs)/polymeric resins may be incorporated into one or more layers of the display/display device/display panel that include, but are not limited to: a seal layer, a cathode layer, an emissive layer, an adhesive layer, a conductive layer, an anode layer, a substrate layer, and any layers mentioned in reference to FIG. 2. It is understood that the display/display device/display panel may include additional film layers that are not mentioned herein.

In an embodiment of the present disclosure, an electronic device may be provided that may utilize one or more optically clear adhesives (OCAs)/polymeric resins of the present disclosure in a display/display device/display panel associated with the electronic device. For exemplary purposes, the electronic device may be any of: a smart phone, a mobile phone, a video phone, a camera, a wearable device (such as electronic clothing, an electronic accessory, a smart watch, a head-mounted apparatus, an electronic bracelet, an electronic necklace, or an electronic tattoo), a personal digital assistant (PDA), a desktop computer (PC), a laptop PC, a netbook PC, a portable multimedia player (PMP), a digital audio player, a mobile medical apparatus, an e-book reader, etc. In additional embodiments, electronic device may be a smart home appliance including a display/display device/display panel. For exemplary purposes, the smart home appliance may be any of: an electronic key, a stereo, a TV, a set-top box, a television (TV) box, a video recorder, a game console, a vacuum cleaner, a digital video disk (DVD) player, a refrigerator, an air conditioner, an oven, a dryer, an air purifier, a microwave oven, a washing machine, an electronic dictionary, an electronic photo frame, etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, an optically clear adhesive (OCA) comprising: a polymeric resin composition comprising: 30 to 60 wt % of a difunctional thiol monomer; 20 to 60 wt % of a difunctional allyl monomer; and 1 to 5 wt % of a trifunctional allyl monomer.

Clause 2, the optically clear adhesive of Clause 1, wherein the polymeric resin composition further comprises: 10% of a synthesized adhesion promoter; 2% of a phosphine oxide-based photoinitiator; and 0.3% of a wetting additive.

Clause 3, the optically clear adhesive of Clause 1, wherein the polymeric resin composition is cured into a film.

Clause 4, the optically clear adhesive of Clause 3, wherein the polymeric resin composition is cured into the film using UVA light having an intensity of substantially 2-6 J/cm² under ambient temperature.

Clause 5, the optically clear adhesive of Clause 3, wherein, when the film is fully cured, the film comprises a first storage modulus between 0.05 and 0.1 MPa at −20° C. and a second storage modulus between 0.01 and 0.05 MPa at 60° C. when a rate of temperature increase is measured at 5° C./min.

Clause 6, the optically clear adhesive of Clause 3, wherein, when the film is fully cured, the film comprises a modulus of less than 400 kPa at −20° C. and greater than 20 kPa at 60° C.

Clause 7, the optically clear adhesive of Clause 3, wherein the film comprises a haze of less than 1%.

Clause 8, the optically clear adhesive of Clause 3, wherein the film comprises a yellowing index of less than 1.

Clause 9, the optically clear adhesive of Clause 3, wherein the film comprises an optical transmission rate of greater than 90% within the visible wavelength range.

Clause 10, the optically clear adhesive of Clause 3, wherein the film comprises an adhesion force with substrates of greater than 800 gf/in, further wherein the optically clear adhesive is absent a pre-activation or post-treatment of functional groups.

Clause 11, an optical laminate comprising: a first base layer having a first surface; a second base layer having a second surface; and an adhesive layer, wherein the adhesive layer includes an optically clear adhesive (OCA) comprising: a polymeric resin composition comprising: 30 to 60 wt % of a difunctional thiol monomer; 20 to 60 wt % of a difunctional allyl monomer; and 1 to 5 wt % of a trifunctional allyl monomer; wherein the adhesive layer is positioned between the first surface of the first base layer and the second surface of the second base layer so as to adhere the first surface of the first base layer to the second surface of the second base layer.

Clause 12, the optical laminate of Clause 11, wherein the polymeric resin composition further comprises: 10% of a synthesized adhesion promoter; 2% of a phosphine oxide-based photoinitiator; and 0.3% of a wetting additive.

Clause 13, a method for synthesizing a difunctional adhesion promoting monomer of an optically clear adhesive (OCA), wherein a process illustrated by following Reaction Formula 1 is carried out.

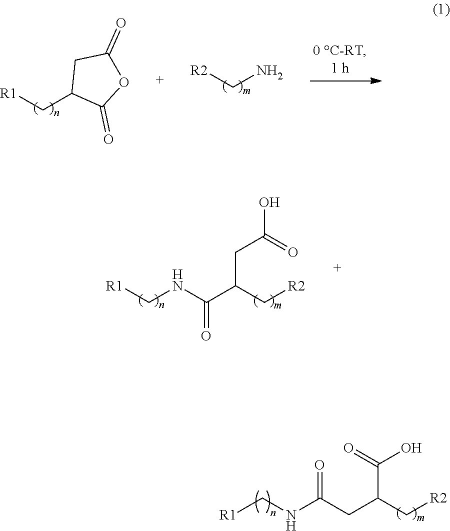

Clause 14, the method of Clause 13, wherein the process is solvent-free.

Clause 15, the method of Clause 13, wherein each of the R1 and R2 functional groups are photopolymerizable functional groups.

Clause 16, the method of Clause 15, wherein the photopolymerizable functional groups include any of: terminal alkenes, terminal alkynes, and terminal acrylates.

Clause 17, the method of Clause 13, wherein the process proceeds without producing side products or solvent residues in a final product.

Clause 18, the method of Clause 13, wherein the process comprises a ratio of a diallyl monomer to a cross-linker of between 5 to 1 and 10 to 1.

Clause 19, a flexible display comprising: a window layer; a polarizer layer; a display layer; a support film layer; and a plurality of adhesive layers, wherein each of the plurality of adhesive layers includes an optically clear adhesive (OCA) comprising: 30 to 60 wt % of a difunctional thiol monomer; 20 to 60 wt % of a difunctional allyl monomer; and 1 to 5 wt % of a trifunctional allyl monomer; wherein a first adhesive layer of the plurality of adhesive layers is positioned between a first surface of the window layer and a first surface of the polarizer layer, a second adhesive layer is positioned between a second surface of the polarizer layer and a first surface of the display layer, and a third adhesive layer is positioned between a second surface of the display layer and a first surface of the support film layer so as to adhere the first surface of the window layer to the first surface of the polarizer layer, the second surface of the polarizer layer to the first surface of the display layer, and the second surface of the display layer to the first surface of the support film layer.

Clause 20, the flexible display of Clause 19, wherein the polymeric resin composition further comprises: 10% of a synthesized adhesion promoter; 2% of a phosphine oxide-based photoinitiator; and 0.3% of a wetting additive.

What is claimed is:

1. An optically clear adhesive (OCA) comprising:
a polymeric resin composition comprising:
30 to 60 wt % of a difunctional thiol monomer;
20 to 60 wt % of a difunctional allyl monomer; and
1 to 5 wt % of a trifunctional allyl monomer.

2. The optically clear adhesive of claim 1, wherein the polymeric resin composition further comprises:
10% of a synthesized adhesion promoter;
2% of a phosphine oxide-based photoinitiator; and
0.3% of a wetting additive.

3. The optically clear adhesive of claim 1, wherein the polymeric resin composition is cured into a film.

4. The optically clear adhesive of claim 3, wherein the polymeric resin composition is cured into the film using UVA light having an intensity of substantially 2-6 J/cm² under ambient temperature.

5. The optically clear adhesive of claim 3, wherein, when the film is fully cured, the film comprises a first storage modulus between 0.05 and 0.1 MPa at −20° C. and a second storage modulus between 0.01 and 0.05 MPa at 60° C. when a rate of temperature increase is measured at 5° C./min.

6. The optically clear adhesive of claim 3, wherein, when the film is fully cured, the film comprises a modulus of less than 400 kPa at −20° C. and greater than 20 kPa at 60° C.

7. The optically clear adhesive of claim 3, wherein the film comprises a haze of less than 1%.

8. The optically clear adhesive of claim 3, wherein the film comprises a yellowing index of less than 1.

9. The optically clear adhesive of claim 3, wherein the film comprises an optical transmission rate of greater than 90% within the visible wavelength range.

10. The optically clear adhesive of claim 3, wherein the film comprises an adhesion force with substrates of greater than 800 gf/in, further wherein the optically clear adhesive is absent a pre-activation or post-treatment of functional groups.

11. An optical laminate comprising:
a first base layer having a first surface;
a second base layer having a second surface; and
an adhesive layer, wherein the adhesive layer includes an optically clear adhesive (OCA) comprising:
a polymeric resin composition comprising:
30 to 60 wt % of a difunctional thiol monomer;
20 to 60 wt % of a difunctional allyl monomer; and
1 to 5 wt % of a trifunctional allyl monomer;
wherein the adhesive layer is positioned between the first surface of the first base layer and the second surface of the second base layer so as to adhere the first surface of the first base layer to the second surface of the second base layer.

12. The optical laminate of claim 11, wherein the polymeric resin composition further comprises:
10% of a synthesized adhesion promoter;
2% of a phosphine oxide-based photoinitiator; and
0.3% of a wetting additive.

13. A method for synthesizing a difunctional adhesion promoting monomer of an optically clear adhesive (OCA), wherein a process illustrated by following Reaction Formula 1 is carried out.

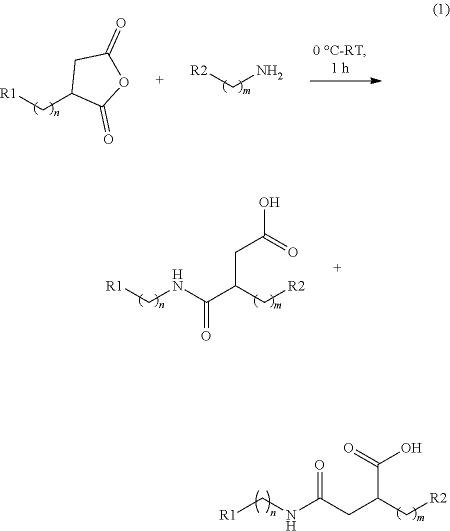

14. The method of claim 13, wherein the process is solvent-free.

15. The method of claim 13, wherein each of the R1 and R2 functional groups are photopolymerizable functional groups.

16. The method of claim 15, wherein the photopolymerizable functional groups include any of: terminal alkenes, terminal alkynes, and terminal acrylates.

17. The method of claim 13, wherein the process proceeds without producing side products or solvent residues in a final product.

18. The method of claim 13, wherein the process comprises a ratio of a diallyl monomer to a cross-linker of between 5 to 1 and 10 to 1.

19. A flexible display comprising:
a window layer;
a polarizer layer;
a display layer;
a support film layer; and
a plurality of adhesive layers, wherein each of the plurality of adhesive layers includes an optically clear adhesive (OCA) comprising:
30 to 60 wt % of a difunctional thiol monomer;
20 to 60 wt % of a difunctional allyl monomer; and
1 to 5 wt % of a trifunctional allyl monomer;
wherein a first adhesive layer of the plurality of adhesive layers is positioned between a first surface of the window layer and a first surface of the polarizer layer, a second adhesive layer is positioned between a second surface of the polarizer layer and a first surface of the display layer, and a third adhesive layer is positioned between a second surface of the display layer and a first surface of the support film layer so as to adhere the first surface of the window layer to the first surface of the polarizer layer, the second surface of the polarizer layer to the first surface of the display layer, and the second surface of the display layer to the first surface of the support film layer.

20. The flexible display of claim 19, wherein the polymeric resin composition further comprises:
10% of a synthesized adhesion promoter;
2% of a phosphine oxide-based photoinitiator; and
0.3% of a wetting additive.
